(19) United States
(12) Patent Application Publication
(10) Pub. No.: US 2025/0181957 A1
(43) Pub. Date: Jun. 5, 2025

(54) TEMPORAL QUANTUM FEATURE MAPS FOR KERNEL-BASED SEQUENTIAL DATA PREDICTION

(71) Applicants: International Business Machines Corporation, Armonk, NY (US); Wells Fargo Bank, N.A., Minneapolis, MN (US)

(72) Inventors: Vladimir Rastunkov, Mundelein, IL (US); Daniel Joseph Fry, Bucuresti (RO); Vanio Slavov Markov, Ridgewood, NJ (US)

(21) Appl. No.: 18/524,891

(22) Filed: Nov. 30, 2023

(51) Int. Cl. G06N 10/60; G06N 20/10

(52) U.S. Cl. CPC G06N 10/60; G06N 20/10

(57) ABSTRACT

One or more systems, devices, computer program products and/or computer-implemented methods of use provided herein relate to TQFMs for kernel-based sequential data prediction. A system can comprise a memory that can store computer-executable components. The system can further comprise a processor that can execute the computer-executable components stored in the memory, wherein the computer-executable components can comprise a computation component that can use a TQFM to compute a kernel element between two sequences of symbols, on a quantum computer, by respectively processing two input sequences as vectors.

### BACKGROUND

The subject disclosure relates to quantum computing, and, more specifically, to temporal quantum features maps (TQFMs) for kernel-based sequential data prediction.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable TQFMs for kernel-based sequential data prediction are discussed.

According to an embodiment, a system is provided. The system can comprise a memory that can store computer-executable components. The system can further comprise a processor that can execute the computer-executable components stored in the memory, where the computer-executable components can comprise a computation component that can use a TQFM to compute a kernel element between two sequences of symbols, on a quantum computer, by respectively processing two input sequences as vectors.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ TQFMs for kernel-based sequential data prediction in accordance with one or more embodiments described herein.

FIG. 2 illustrates a network diagram of an example, non-limiting system for forecasting data in accordance with one or more embodiments described herein.

FIG. 3 illustrates a flow diagram of an example, non-limiting method for training a forecasting model using a TQFM in accordance with one or more embodiments described herein.

FIG. 4 illustrates a diagram of an example, non-limiting representation of quantum circuits based on a unitary TQFM in accordance with one or more embodiments described herein.

FIG. 5 illustrates a diagram of an example, non-limiting representation of quantum circuits based on a non-unitary TQFM in accordance with one or more embodiments described herein.

FIG. 6 illustrates diagrams of example, non-limiting quantum circuits showing circuit implementations for a unitary evolution and a non-unitary evolution in accordance with one or more embodiments described herein.

FIG. 7A illustrates a diagram of an example, non-limiting quantum circuit showing a non-unitary evolution in accordance with one or more embodiments described herein.

FIG. 7B illustrates a diagram of an example, non-limiting colorbar plot of a kernel matrix based on a non-unitary evolution in accordance with one or more embodiments described herein.

FIG. 8 illustrates diagrams of example, non-limiting concepts related to reservoir computing in accordance with one or more embodiments described herein.

FIG. 9 illustrates a flow diagram of an example, non-limiting method that can employ TQFMs for kernel-based sequential data prediction in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

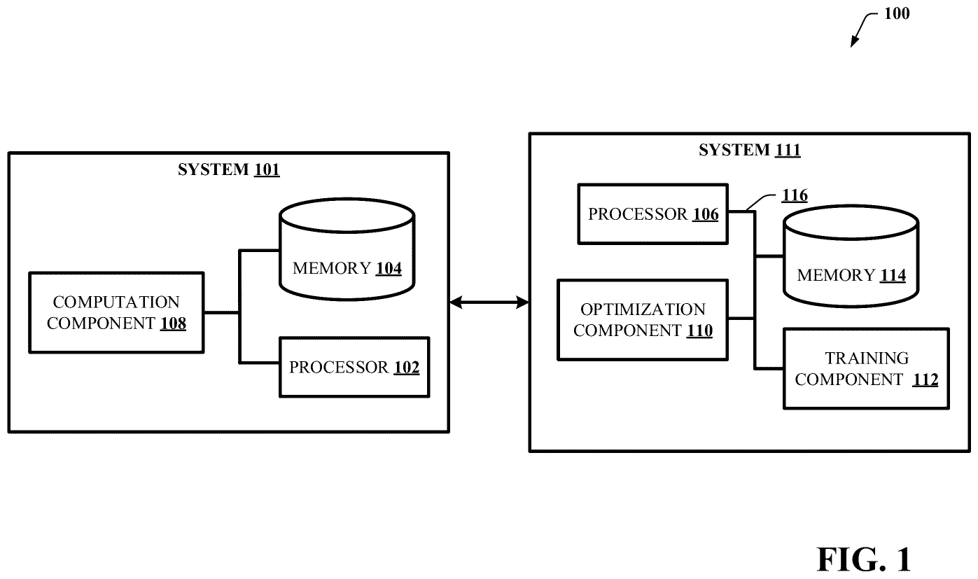

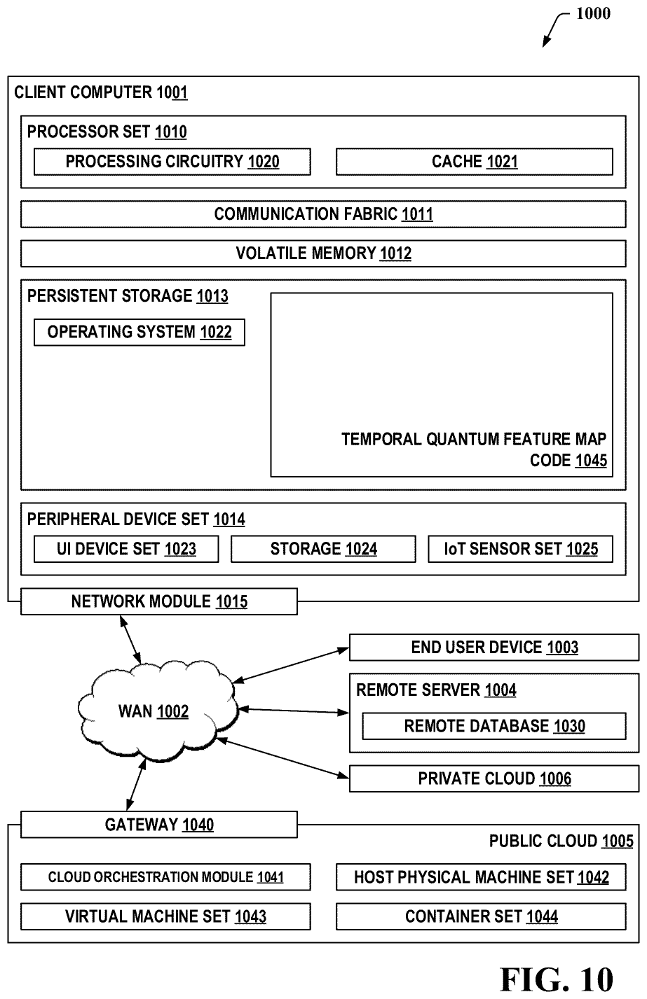

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

Financial time series are very difficult to predict due to several factors. Firstly, the inherent complexity and a dynamic nature of financial markets make accurate forecasting a challenging endeavor. Financial markets are influenced by a vast array of interconnected factors, including economic indicators, geopolitical events, investor sentiment, and regulatory changes. The interplay of these variables creates an intricate web of relationships that is challenging to decipher. Secondly, financial data is often characterized by high volatility, non-linear patterns, and intermittent trends, making identification of reliable patterns difficult for forecasting. Additionally, financial markets are prone to unexpected shocks and black swan events, such as financial crises or sudden market fluctuations, which can significantly disrupt conventional forecasting models. Further, a presence of noise and outliers in financial data further complicates the prediction process, as separating random fluctuations from meaningful signals becomes challenging. Finally, an availability of accurate and comprehensive data is crucial for effective forecasting, but financial data is often incomplete, inconsistent, and prone to data mining biases, posing further obstacles to accurate predictions. Overall, the multifaceted nature of financial markets, the unpredictability of market dynamics, the non-linear patterns in financial data, and the presence of various noise and uncertainties make predicting financial time series a formidable task. Analytical models that utilize quantum kernel estimation are widely explored and suitable for near term quantum devices. However, quantum kernel and quantum feature map circuits are currently not well suited for embedding sequential data, especially, in case of sequences with varying lengths. For example, a common approach involving quantum feature maps can embed single data points (e.g., where k=1 for k number of data points). Thus, quantum embedding and quantum feature creation techniques for sequences of different lengths for general sequential prediction applications can be desirable.

Various embodiments of the present disclosure can be implemented to produce a solution to one or more problems discussed above. Embodiments described herein include systems, computer-implemented methods, and computer program products that can implement TQFMs for kernel-based sequential data prediction. For example, various embodiments herein can perform quantum embedding of sequences of variable lengths using TQFMs (or quantum channels). A TQFM can be used to embed k-length sequential data, such as time series data, where k>1 for k number of data points. Further, the sequence length k>1 can be variable in some embodiments. For example, a sequence of length k=m and another sequence of length k=n, where m≠n, can both be embedded to the TQFM with the same number of qubits. Generally, a TQFM can be described as a quantum channel defined as a completely positive (CP) map. The TQFM can have a unitary circuit design, or a non-unitary circuit design based on a quantum reservoir and open quantum systems. The TQFM quantum circuit (or TQFM quantum channel) can be parameterized, such that the TQFM quantum circuit (or the TQFM quantum channel) can be optimized by a suitable optimization algorithm for training for better sequence prediction. The TQFM can be used in a quantum kernel function for a kernel-based time series or sequence prediction algorithm. A quantum kernel function can be a suitable quantum similarity measure or metric computed on a quantum computer. For example, a quantum state fidelity, F, can be a kernel element for sequences encoded to TQFMs. The fidelity can be computed on a quantum computer with a quantum algorithm such as an inversion test, for pure states, or a fidelity algorithm, for mixed states. A kernel matrix can then be populated and used with labelled sequence samples to build a quantum-enhanced support vector machine (SVM) or another kernel-based estimator. Input sequences belonging to a class can be expected to have final TQFM quantum states that are close to each other regardless of the respective sequence lengths of the input sequences. As such, various embodiments herein can propose a new design approach to quantum feature maps, and therefore, to quantum kernels, via a TQFM.

FIG. 1 illustrates a block diagram of an example, non-limiting system 100 that can employ TQFMs for kernel-based sequential data prediction in accordance with one or more embodiments described herein. System 100 can comprise system 101 and system 111, wherein system 101 can be a quantum computing system (e.g., a quantum computer or quantum simulator) and system 111 can be a classical computing system (e.g., a classical computer). System 101 can be operably connected to system 111 for the execution of operations discussed in one or more embodiments herein.

The system 100 and/or the components of the system 100 can be employed to use hardware and/or software to solve problems that are highly technical in nature (e.g., related to quantum computing, TQFMs, kernels, etc.), that are not abstract and that cannot be performed as a set of mental acts by a human. Further, some of the processes performed may be performed by specialized computers for carrying out defined tasks related to kernel-based sequential data prediction using TQFMs. The system 100 and/or components of the system can be employed to solve new problems that arise through advancements in technologies mentioned above, computer architecture, and/or the like. The system 100 can provide technical improvements to machine learning systems by generating a more performant model (e.g., an SVM) for making predictions. For example, various embodiments herein can map sequences into a quantum space (e.g., a Hilbert space) that can be much larger that a classical set up. The quantum space can allow for a better separation of states representing different sequences (e.g., time series) as compared to classical computing. In other words, encoding sequence data to quantum states can generate highly comprehensive representations of a sequence. Such representations can leverage high dimensionality of the Hilbert space that can drastically exceed classical dimensions, leading to higher precision in predicting the next symbol in a sequence, which can have wide applicability across different areas, including financial services. One or more embodiments herein can employ contemporary quantum computing hardware. In general, embodiments herein can implement a quantum model of computing which can comprise state superpositions, state entanglements, interferences, etc. that can be represented in circuit-based quantum computing. In quantum computing, superposition of quantum states can play a significant role as the quantum space grows with addition of more qubits. For example, a tensor product and a vector characterizing a single qubit can be two-dimensional (2D), however, that can grow exponentially with addition of more qubits, which can allow for potential superpositions states. Further, quantum-enhanced SVMs can demonstrate quantum advantage with access to classical data for a classification task.

Discussion turns briefly to processor 102 and memory 104 of system 101. For example, in one or more embodiments, system 101 can comprise processor 102 (e.g., a quantum processing unit (QPU)). In one or more embodiments, a component associated with system 101, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s). In one or more embodiments, system 101 can comprise a computer-readable memory (e.g., memory 104) that can be operably connected to processor 102. Memory 104 can store computer-executable instructions that, upon execution by processor 102, can cause processor 102 and/or one or more other components of system 101 (e.g., computation component 108) to perform one or more actions. In one or more embodiments, memory 104 can store the computer-executable components (e.g., computation component 108).

Discussion turns next to processor 106, memory 114 and bus 116 of system 111. For example, in one or more embodiments, the system 111 can comprise processor 106 (e.g., computer processing unit, microprocessor, classical processor, and/or like processor). In one or more embodiments, a component associated with system 111, as described herein with or without reference to the one or more figures of the one or more embodiments, can comprise one or more computer and/or machine readable, writable and/or executable components and/or instructions that can be executed by processor 106 to enable performance of one or more processes defined by such component(s) and/or instruction(s). In one or more embodiments, system 111 can comprise a computer-readable memory (e.g., memory 114) that can be operably connected to the processor 106. Memory 114 can store computer-executable instructions that, upon execution by processor 106, can cause processor 106 and/or one or more other components of system 111 (e.g., optimization component 110, and/or training component 112) to perform one or more actions. In one or more embodiments, memory 114 can store computer-executable components (e.g., optimization component 110, and/or training component 112).

System 111 and/or a component thereof as described herein, can be communicatively, electrically, operatively, optically and/or otherwise coupled to one another via bus 116. Bus 116 can comprise one or more of a memory bus, memory controller, peripheral bus, external bus, local bus, and/or another type of bus that can employ one or more bus architectures. One or more of these examples of bus 116 can be employed. In one or more embodiments, system 111 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 111 can reside in the cloud, and/or can reside locally in a local computing environment (e.g., at a specified location(s)).

System 100 can comprise one or more computer and/or machine readable, writable and/or executable components and/or instructions that, when executed by processor 102 and/or processor 106, can enable performance of one or more operations defined by such component(s) and/or instruction(s). For example, system 100 can be employed towards generating predictions of financial time series such as, for example, prediction of a mid-price of an asset (e.g., stocks, bonds, etc.) in the limit order book for financial markets. The task of predicting a mid-price for an asset can be formalized by using a binary sequence to represent a behavior of the mid-price. For example, an increase in the mid-price of the asset can be represented by a value of one (1), and a decrease in the mid-price of the asset can be represented by a value of zero (0). The mid-price for the asset can be observed at defined time intervals to generate a binary sequence. For example, an entity (e.g., software, hardware, machine, artificial intelligence (AI) or human entity) can observe a behavior of the mid-price of the asset at a frequency of 1 second(s), and the entity can capture a binary sequence representing the rise and fall of the mid-price over time, based on a 1 s discretization or frequency of data. For example, instead of observing the actual mid-price (e.g., 100 dollars ($), $110, etc.) every second, the entity can take a derivative of the actual mid-price and represent a financial time series as a bitstring.

Operations to translate the actual mid-price of an asset to a binary sequence or a bitstring can be performed on system 111 (e.g., a classical computer). The frequency of recording the mid-price can be variable in different scenarios because financial events can occur at different time intervals. For example, a trade can influence the mid-price in less than 1 second, followed by another trade that can happen in about 1 s. Thus, the frequency of recording the mid-price can be different (e.g., 1 second, 5 seconds, etc.) based on a given scenario. In some embodiments, events can be observed directly, and a sequence can be generated based on a behavior of the mid-price after each event. In such a scenario, the events can be unequally spaced in time.

The mid-price of the asset can be observed at different times (e.g., different times in a day), at defined time intervals (e.g., 1 s intervals, 5 s intervals, etc.), to generate multiple binary sequences or bitstrings. In various embodiments, computation component 108 can use a TQFM to compute a kernel element between two sequences of symbols, on system 111 (e.g., a quantum computer), by respectively processing two input sequences as vectors. In various embodiments, the two input sequences can respectively represent two time series, and computing the kernel element can comprise splitting (e.g., by system 111 or a component of system 111) the two time series into the two sequences of symbols. For example, in various embodiments, the two time series can be broken up (e.g., by system 111) into sequences of binary, decimal, hexadecimal, alphanumeric, Unicode Transformation Format (UTF-8), UTF-16, UTF-32, etc. symbols.

Upon generation of the two bitstrings, system 111 can be further employed to construct a quantum circuit based on the two bitstrings, wherein the quantum circuit can define a set of instructions that can be applied by system 101 to qubits (e.g., qubits of system 101) in a ground state to bring the qubits to a new state based on certain parameters. In other words, the quantum circuit can define a set of instructions called transformations that, when executed by system 101, can allow the two bitstrings to be embedded to respective quantum states. As such, the quantum circuit can comprise layers of quantum gates implemented via TQFMs to embed the two bitstrings into the quantum state. In various embodiments, a resulting quantum state associated with a bitstring can be a pure quantum state or a mixed quantum state.

After constructing the quantum circuit for the two bitstrings, system 111 can send the quantum circuit to system 101 over a network (e.g., a wired network, a wireless network or cloud network), and system 101 can process the quantum circuit to prepare the quantum state. For example, system 101 can apply transformations using the TQFM to embed each bitstring into respective quantum states using the quantum circuit. In some embodiments, the transformations can be unitary transformations, whereas in other embodiments, the transformations can be non-unitary transformations, because quantum computing can involve parametrized quantum gates, and zeroes and ones in a binary sequence (e.g., a bitstring) can be embedded differently using unitary transformation and non-unitary transformations. Unitary transformations can be applied by a unitary TQFM, and non-unitary transformations can be applied using a non-unitary TQFM. As such, in some embodiments, the TQFM can be a unitary TQFM, whereas in other embodiments the TQFM can be a non-unitary TQFM (or a mixed state TQFM). Stated differently, the TQFM can have a unitary circuit design, or a non-unitary circuit design based on a quantum reservoir and open quantum systems. A quantum reservoir-inspired temporal feature map (or TQFM) can fall under both unitary and non-unitary approaches. As stated elsewhere herein, a TQFM can be described as a quantum channel. In various embodiments, the quantum channel can represent non restricted dynamics of an open quantum system that can allow for information dissipation into an environment and information flow from the environment. In some embodiments, the quantum channel can be CP for the non-unitary TQFM. In some embodiments, the quantum channel can be completely positive and trace preserving (CPTP) for the non-unitary TQFM.

In various embodiments, the TQFM quantum circuit (or TQFM quantum channel) can be parameterized, such that the TQFM quantum circuit (or the TQFM quantum channel) can be optimized by a suitable optimization algorithm for training (e.g., training a model) for better sequence prediction. For example, optimization component 110 can parametrize the quantum channel to optimize the quantum channel using an optimization algorithm and generate an optimized quantum channel, and training component 112 can train a model for sequence prediction using the optimized quantum channel. The TQFM can be used in a quantum kernel function for a kernel-based time series or sequence prediction algorithm. A quantum kernel function can be a suitable quantum similarity measure or metric computed on system 101. For example, a quantum state fidelity, F, can be a kernel element for sequences encoded to TQFMs. The fidelity can be computed by computation component 108 on system 101 with a quantum algorithm such as an inversion test, for pure states, or a fidelity algorithm, for mixed states. A kernel matrix can then be populated and used with labelled sequence samples to build (e.g., by training component 112) a quantum-enhanced SVM or another kernel-based estimator.

For example, a sequence (e.g., a bitstring) x can be described as {xᵢ}ᵢ₌₀^{N}∈ [symbol] ^{N} or as a vector x∈ [symbol] ^{N}, wherein x=[x₀, x₁, . . . , x_{N}]^{T}. In some implementations the sequence can be represented as a discrete time stochastic process {yᵢ: i∈ [symbol] , yᵢ ∈Σ}, wherein Σ can represent a finite set of observable symbols, called alphabet. Embedding the sequence to a quantum feature map (e.g., the TQFM) can be given by x→ϕ(x), wherein ϕ(x) can be a representation of the sequence x in the Hilbert space, which is a high-dimensional quantum space. System 101 can employ the TQFM in a kernel function K(x, z)∈ [symbol] , wherein x can correspond to the sequence x and z can correspond to a different sequence z such that the kernel function can be used to determine a kernel element (e.g., fidelity) between sequences x and z. The fidelity computed by computation component 108 for the pair of sequences x and z can be used to populate a kernel matrix Kᵢⱼ ∈ [symbol] ^{N×M}. As discussed above, the TQFM can be unitary or non-unitary. A unitary TQFM can be represented by xᵢ→|ϕ(xᵢ) [symbol] ∈ [symbol] ^{N} for a sequence x of a pair of sequences x and z, and the corresponding kernel function can be represented as K(x, z)=S (|ϕ(x)>, |ϕ(z) [symbol] ). The relation xᵢ→|ϕ(xᵢ) [symbol] ∈ [symbol] ^{N} can indicate that the sequence x can be embedded in a quantum Hilbert space of dimension N, however, either index can be used in the notation as long as it is consistent. A Hilbert space is a complex vector space. Likewise, a non-unitary TQFM can be represented by xᵢ→ρ_{ϕ}(xᵢ)∈ [symbol] ^{N×N} for a sequence x of a pair of sequences x and z, and the corresponding kernel function can be represented as K(x, z)=S (ρ_{ϕ}(x), ρ_{ϕ}(z)). In case of a financial time series, for example, a mid-price of a security in the limit order book, the financial time series can be mapped to a Hilbert space which is a high-dimensional quantum space. The |ϕ(x)) and |ϕ(z) [symbol] can represent TQFMs that can be used to perform transformations and generate quantum states for sequences x and z. A distance between the quantum states can be used to construct (e.g., by computation component 108) a kernel matrix, and training component 112 can train the model to classify feature sequences using the model. In various embodiments, a longer input sequence can be included with subsequent input sequences for training the TQFM.

Thus, after embedding bitstring data for each bitstring into respective TQFMs, computation component 108 can perform computations to calculate a kernel element. A TQFM can be a representation of data (e.g., bitstrings) on a quantum device. For all pairs of sequences, a set of unitaries can be created, wherein the set of unitaries can represent the transformations that can be applied to each pair of sequences. The quantum circuit can be run by system 100 to prepare a quantum state, and also to compare two quantum states for two different sequences. For example, given binary sequences 101 and 111, computation component 108 can calculate a kernel element that can represent a distance between final quantum states of the two sequences. Thus, the kernel element can be calculated as a distance between respective final quantum states of a pair of sequences, and the kernel element can populate a kernel matrix that can be employed by a kernel-based machine learning method (e.g., SVM) for predicting financial time series. In an embodiment, the two input sequences can be processed (e.g., by computation component 108) as respective vectors having equal lengths. In another embodiment, the two input sequences can be processed (e.g., by computation component 108) as respective vectors having different lengths.

Further, in various embodiments, a number of qubits of a TQFM can be a hyperparameter that is not directly determined by a length of an input sequence to be embedded. For example, considering a unitary TQFM, a number of qubits of the TQFM quantum circuit can be independent of the length of a sequence being embedded. Rather, the number of qubits of a feature map or reservoir can be a hyperparameter not directly determined by the length of the sequence (e.g., a time series sequence/bitstring/binary sequence) to be embedded. For example, for mapping binary sequences to quantum states with parameterized TQFMs, U(θ), a TQFM quantum circuit can map sequences of different length as follows. For two binary sequences s₁=010 of length 3 (i.e., 3 data points, 0, 1 and 0) and s₂=11 of length 2 (i.e., 2 data points, 1 and 1), s₁ and s₂ can be respectively represented as parameter vectors θₛ_{₁} and θ̅ₛ_{₂}. Sequences s₁ and s₂ can be embedded as given by equation 1 and equation 2, respectively.

$${\underline{θ}}_{{s}_{1}} = {[ 0 , 1 , 0 ]}^{T} \to U ( {\underline{θ}}_{{s}_{1}} ) \vert 0 〉 = U ( 0 ) U ( 1 ) U ( 0 ) \vert 0 〉 \qquad Equation 1$$

$${\underline{θ}}_{{s}_{2}} = {[ 1 , 1 ]}^{T} \to U ( {\underline{θ}}_{{s}_{2}} ) \vert 0 〉 = U ( 1 ) U ( 1 ) \vert 0 〉 \qquad Equation 2$$

In equation 1 and 2, |0 [symbol] =|0 [symbol] ^{⊗n}, wherein n can represent the same number of qubits for TQFM circuits U(θₛ_{₁}) and U(θₛ_{₂}). In general, equations 1 and 2 can be represented as \dot{θ}ₛ→U(θₛ)|0 [symbol] =Πᵢ₌₀^{N}Uᵢ (θᵢ)|0 [symbol] . A corresponding quantum kernel function for sequences s₁ and s₂ can be a pure state fidelity given by equation 3.

$$K ( {s}_{1} , {s}_{2} ) = {\vert 〈 0 \vert {U}^{†} ( {\underline{θ}}_{{s}_{2}} ) U ( {\underline{θ}}_{{s}_{1}} ) \vert 0 〉 \vert}^{2} \qquad Equation 3$$

In the notation |0 [symbol] =|0 [symbol] ^{⊗n}, the symbol, ⊗, can represent a tensor product, and n can indicate the number of qubits in the quantum circuit. Together, the notation, |0 [symbol] ^{⊗n}, can represent n qubits in the zero state. For example, for a system of two qubits, each qubit can have an associated vector of dimension 2. Thus, [0,1] and [1,0] can represent two possible states of 0 and 1, and for the two qubits, the tensor product can yield a final state vector of dimension 4.

Further, in the notations described above, U can represent a unitary and U(0), U(1), and so on can represent quantum circuit blocks. For example, for a 4-qubit quantum circuit, the first block of the quantum circuit can be represented as a unitary, and the quantum circuit can be broken into a series of unitaries. In terms of quantum circuits and operations on qubits, U can represent operations on multiple qubits at the same time. Stated differently, and initial state of a quantum system can be a vector of values, and the U matrices can be multiplied on the vector to generate a vector output. Subsequently, different unitaries can be applied. For example, U(0) can represent a transformation with a parameter equal to zero, which can be written as a matrix. Thereafter, additional matrices can be considered, and the original state of the quantum system (e.g., the vector of values) can be multiplied by the additional matrices. As quantum states become larger, such computations involving matrices and vectors can be performed on a quantum device that can natively process unitaries and states, as described by the various embodiments herein. Additional aspects of the various embodiments herein are described with reference to subsequent figures.

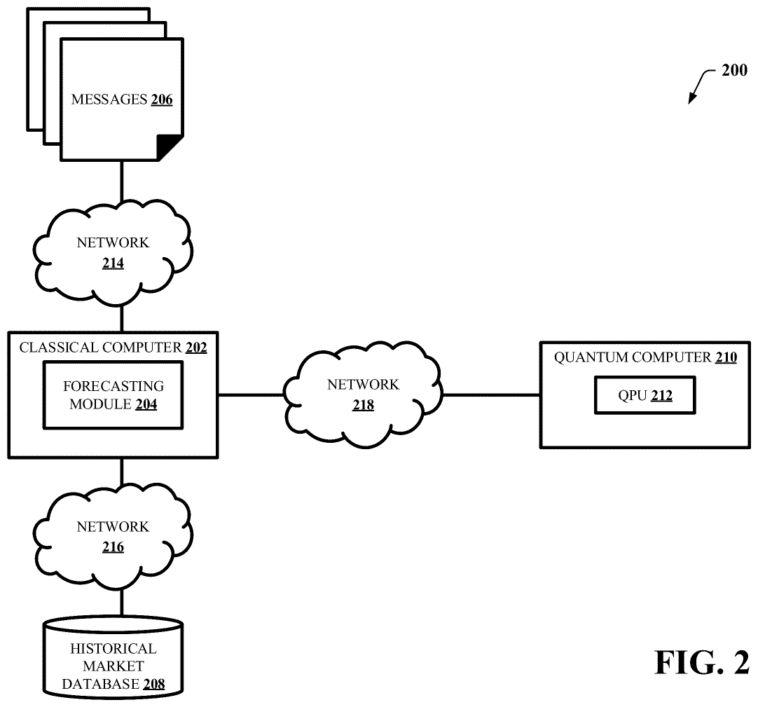

FIG. 2 illustrates a network diagram of an example, non-limiting system 200 for forecasting data in accordance with one or more embodiments described herein. One or more embodiments discussed with reference to FIG. 2 can be enabled by one or more components of FIG. 1. Repetitive description of like elements and/or processes employed in respective embodiments is omitted for sake of brevity.

Financial sequences can be expressed as languages with finite alphabets. In the most primitive form, the market alphabet can contain two symbols, for example, U (up) and D (down). Given a sequence of symbols, which can be called a prefix, various embodiments herein can aim to identify the most likely behavior of a financial sequence in the future, which can be called a suffix, and, ideally, a distribution of such behavior. In some implementations or embodiments, raw sequences with continuous values can be considered. In other implementations or embodiments, a sequence can comprise vectors (e.g., a multivariate time series). The network diagram of FIG. 2 illustrates system 200, wherein system 200 can comprise components for forecasting financial time series data using kernel methods, and wherein kernel elements can be estimated using TQFMs. System 200 can comprise quantum computer 210 that can run QPU 212, classical computer 202 that can run forecasting module 204, historical market database 208, messages 206, network 214, network 216 and network 218. System 200 can be analogous to system 100 such that quantum computer 210 can comprise computation component 108, and classical computer 202 can comprise optimization component 110 and training component 112. Classical computer 202 can be connected to historical market database 208 via network 216, wherein network 216 can be a wired network, a wireless network, or a cloud network, for acquiring training data. Classical computer 202 can also be connected to messages 206 via network 214, wherein network 214 can be a wired network, a wireless network, or a cloud network, and wherein messages 206 can represent a real-time message feed (e.g., real-time behavior of a mid-price for an asset) for generating predictions. Further, classical computer 202 can be connected to quantum computer 210 running QPU 212, via network 218, wherein network 218 can be a wired network, a wireless network, or a cloud network. In various embodiments, classical computer 202 can translate calculations of kernel elements into quantum circuits and send the quantum circuits for execution to QPU 212.

In various embodiments, classical computer 202 can receive messages 206 over network 214 from a real-time data feed, and classical computer 202 can receive historical sequences over network 216 from historical market database 208, wherein historical market database 208 can comprise all possible sequences from history. Classical computer 202 (or a component of classical computer 202) can map messages 206 (e.g., a suffix) to the historical sequences (e.g., a prefix) on classical computer 202, and a model employed by forecasting module 204 can be trained by training component 112, using a kernel matrix, to generate predictions based on financial time series data based on the mapping. For example, classical computer 202 can employ forecasting module 204 to generate predictions of financial time series such as, for example, mid-prices of an asset (e.g., stocks, bonds, etc.) for financial markets. The task of predicting a mid-price for an asset can be formalized by using a binary sequence to represent a behavior of the mid-price. For example, an increase in the mid-price of the asset can be represented by a value of one (1), and a decrease in the mid-price of the asset can be represented by a value of zero (0). The mid-price for the asset can be observed at defined time intervals to generate a binary sequence. For example, an entity (e.g., software, hardware, machine, AI or human entity) can observe a behavior of the mid-price of the asset at a frequency of 1 s, and the entity can capture a binary sequence representing the rise and fall of the mid-price over time, based on a 1 s discretization or frequency of data.

In some embodiments, sequences can be binary, whereas in other embodiments, sequences can be generalized to more sophisticated situations wherein there can be different behaviors. For example, instead of using binary symbols, four symbols can be used. For example, to represent relative degrees of variation in the mid-price of an asset, the numbers 0, 1, 2 and 3 can be used to form a sequence of symbols, such that 0 can represent the mid-price being down, 1 can represent the mid-price being a little bit down (e.g., slightly higher than the mid-price represented by 0), 2 can represent the mid-price being a little bit up (e.g., slightly lower than the mid-price represented by 3), and 3 can represent the mid-price being up. Thus, in some embodiments, data can be discretized differently to generate a sequence having more than 2 symbols, that is, a sequence of general symbols. In some embodiments, symbols can also be decimal values. In either scenario, that is, in case of binary symbols or generalized, non-binary symbols, the process of generating a kernel matrix on quantum computer 210 can remain the same, however, non-binary symbols can be represented differently in terms of unitaries. The following description considers binary symbols for the sake of simplicity.

Operations to translate the actual mid-price of an asset to a binary sequence or a bitstring can be performed on classical computer 202, wherein classical computer 202 can consider a sign of a derivative of an actual mid-price at a point in time, regardless of an amount of fluctuation of the mid-price. Multiple sequences can be considered wherein a history of the time series can be known (e.g., from historical market database 208), and a model can be built (e.g., by training component 112) by comparing different sequences of different lengths based on historical knowledge of the sequences and predicted future values to identify similarities and predict a future class. As stated elsewhere herein, the frequency of recording the mid-price can be variable in different scenarios because financial events can occur at different time intervals. For example, a trade can influence the mid-price in less than 1 second, followed by another trade that can happen in about 1 s. Thus, the frequency of recording the mid-price can be different (e.g., 1 second, 5 seconds, etc.) based on a given scenario. In some embodiments, events can be observed directly, and a sequence can be generated based on a behavior of the mid-price after each event. In such a scenario, the events can be unequally spaced in time.

Based on the binary sequences, forecasting module 204 can employ the model to predict future financial events. For example, forecasting module can predict whether the financial market will go up or down. In various embodiments, the prediction task can be treated as a classification task due to the sequences being binary and forecasting module 204 can observe sequences of variable lengths to predict whether the sequence is going up or down. Thus, a target of the prediction can be in the future and the binary sequences used to make the prediction can be in the past and already observed. Thus, in addition to being a classification task, the task can also be predictive, wherein forecasting module 204 can predict a class in the future.

The model used by forecasting module 204 to make predictions based on the financial time series can be a quantum-enhanced SVM or another kernel-based estimator, and the model can be trained by training component 112 using a kernel-matrix. For example, in various embodiments, a TQFM can be used to embed a pair of binary sequences to the TQFM with the same number of qubits. Generally, a TQFM can be described as a quantum channel defined as a CP map. The TQFM can have a unitary circuit design, or a non-unitary circuit design based on a quantum reservoir and open quantum systems. The TQFM quantum circuit (or TQFM quantum channel) can be parameterized, such that the TQFM quantum circuit (or the TQFM quantum channel) can be optimized by a suitable optimization algorithm for training for better sequence prediction. The TQFM can be used in a quantum kernel function for a kernel-based time series or sequence prediction algorithm. A quantum kernel function can be a suitable quantum similarity measure or metric computed on quantum computer 210. For example, computation component 108 can use a TQFM to compute a kernel element between two sequences of symbols, on quantum computer 210, by respectively processing the two input sequences (e.g., two binary sequences or bitstrings) as vectors. For example, a quantum state fidelity, F, can be a kernel element for sequences encoded to TQFMs. The fidelity can be computed on quantum computer 210 with a quantum algorithm such as an inversion test, for pure states, or a fidelity algorithm, for mixed states. Input sequences belonging to a class can be expected to have final TQFM quantum states that are close to each other regardless of the respective sequence lengths of the input sequences. The kernel matrix can then be populated and used with labelled sequence samples to build (e.g., by training component 112) the quantum-enhanced SVM or another kernel-based estimator.

In various embodiments, computing the kernel element can comprise splitting (e.g., by system 111 or a component of system 111) the two time series into the two sequences of symbols (e.g., two bitstrings). For example, in various embodiments, the two time series can be broken up (e.g., by system 111) into sequences of binary, decimal, hexadecimal, alphanumeric, UTF-8, UTF-16, UTF-32, etc. symbols. Upon generation of the two bitstrings, the classical computer can be further employed to construct a quantum circuit based on the two bitstrings, wherein the quantum circuit can define a set of instructions that can be applied by quantum computer 210 to qubits (e.g., qubits of QPU 212) in a ground state to bring the qubits to a new state based on certain parameters. For example, classical computer 202 can combine the two binary sequences or bitstrings into a set of instructions called transformation or circuits. The set of instructions of the quantum circuit, when executed by a quantum computer 210, can allow the two bitstrings to be embedded to respective quantum states. For all pairs of input sequences, classical computer 202 can create a set of unitaries, wherein the set of unitaries can represent the transformations that can be applied to each pair of sequences. The quantum circuit can be run by quantum computer 210 to prepare the quantum state, and to compare two quantum states for the two input sequences. In various embodiments, a resulting quantum state associated with a bitstring can be a pure quantum state or a mixed quantum state. In an embodiment, the two input sequences can be processed as respective vectors having equal lengths. In another embodiment, the two input sequences can be processed as respective vectors having different lengths.

After constructing the quantum circuit for the two bitstrings, classical computer 202 can send the quantum circuit to quantum computer 210 through network 218, and quantum computer 210 can execute the quantum circuit to generate a kernel matrix. Quantum computer 210 can send the kernel matrix to classical computer 202 through network 218. More specifically, upon receiving the quantum circuit, quantum computer 210 can process the quantum circuit to prepare the quantum state. For example, quantum computer 210 can apply the transformations using a TQFM to embed each bitstring into respective quantum states using the quantum circuit. In some embodiments, the transformations can be unitary transformations, whereas in other embodiments, the transformations can be non-unitary transformations, because quantum computing can involve parametrized quantum gates, and zeroes and ones in a binary sequence (e.g., a bitstring) can be embedded differently using unitary transformation and non-unitary transformations. Unitary transformations can be applied by a unitary TQFM, and non-unitary transformations can be applied using a non-unitary TQFM. As such, in some embodiments, the TQFM can be a unitary TQFM, whereas in other embodiments the TQFM can be a non-unitary TQFM (or a mixed state TQFM).

As stated elsewhere herein, a TQFM can be described as a quantum channel. In various embodiments, the quantum channel can represent non restricted dynamics of an open quantum system that can allow for information dissipation into an environment and information flow from the environment. In some embodiments, the quantum channel can be CP for the non-unitary TQFM. In some embodiments, the quantum channel can be CPTP for the non-unitary TQFM. In various embodiments, the TQFM quantum circuit (or TQFM quantum channel) can be parameterized, such that the TQFM quantum circuit (or the TQFM quantum channel) can be optimized by a suitable optimization algorithm for training for better sequence prediction. For example, optimization component 110 can parametrize the quantum channel to optimize the quantum channel using an optimization algorithm and generate an optimized quantum channel, and training component 112 can train a model for sequence prediction using the optimized quantum channel. As discussed earlier, the TQFM can be used in a quantum kernel function for a kernel-based time series or sequence prediction algorithm. A quantum kernel function can be a suitable quantum similarity measure or metric computed on a quantum computer. For example, a quantum state fidelity, F, can be a kernel element for sequences encoded to TQFMs.

For example, a sequence (e.g., a bitstring) x can be described as {xᵢ}ᵢ₌₀^{N}∈ [symbol] ^{N} or as a vector x∈ [symbol] ^{N}, wherein x=[x₀, x₁, . . . , x_{N}]^{T}. In some implementations the sequence can be represented as a discrete time stochastic process {yᵢ: i∈ [symbol] , yᵢ∈Σ}, wherein Σ can represent a finite set of observable symbols, called alphabet. Embedding the sequence to a quantum feature map (e.g., the TQFM) can be given by x→ϕ(x), wherein ϕ(x) can be a representation of the sequence x in the Hilbert space, which is a high-dimensional quantum space. Quantum computer 210 can employ the TQFM in a kernel function K(x, z)∈ [symbol] , wherein x can correspond to the sequence x and z can correspond to a different sequence z such that the kernel function can be used to determine a kernel element (e.g., fidelity) between sequences x and z. The fidelity computed by computation component 108 for the pair of sequences x and z can be used to populate a kernel matrix Kᵢⱼ∈ [symbol] ^{N×M}. As discussed above, the TQFM can be unitary or non-unitary. A unitary TQFM can be represented by xᵢ→|ϕ(xᵢ) [symbol] ∈ [symbol] ^{N} for a sequence x of a pair of sequences x and z, and the corresponding kernel function can be represented as K(x, z)=S(|ϕ(x) [symbol] , |ϕ(z) [symbol] ). Likewise, a non-unitary TQFM can be represented by xᵢ→ρ_{ϕ}(xᵢ)∈ [symbol] ^{N×N} for a sequence x of a pair of sequences x and z, and the corresponding kernel function can be represented as K(x, z)=S (ρ_{ϕ}(x), ρ_{ϕ}(z)). Thus, after embedding bitstring data for each bitstring into respective TQFMs, computation component 108 can perform computations to calculate a kernel element. In case of a financial time series, for example, a mid-price of a security from limit order book, the financial time series can be mapped to a Hilbert space which is a high-dimensional quantum space. The |ϕ(x)) and |ϕ(z) [symbol] can represent TQFMs that can be used to perform transformations and generate quantum states (e.g. by quantum computer 210) for sequences x and z. A distance between the quantum states can be used to construct a kernel matrix, and training component 112 can train the model to classify feature sequences using the model.

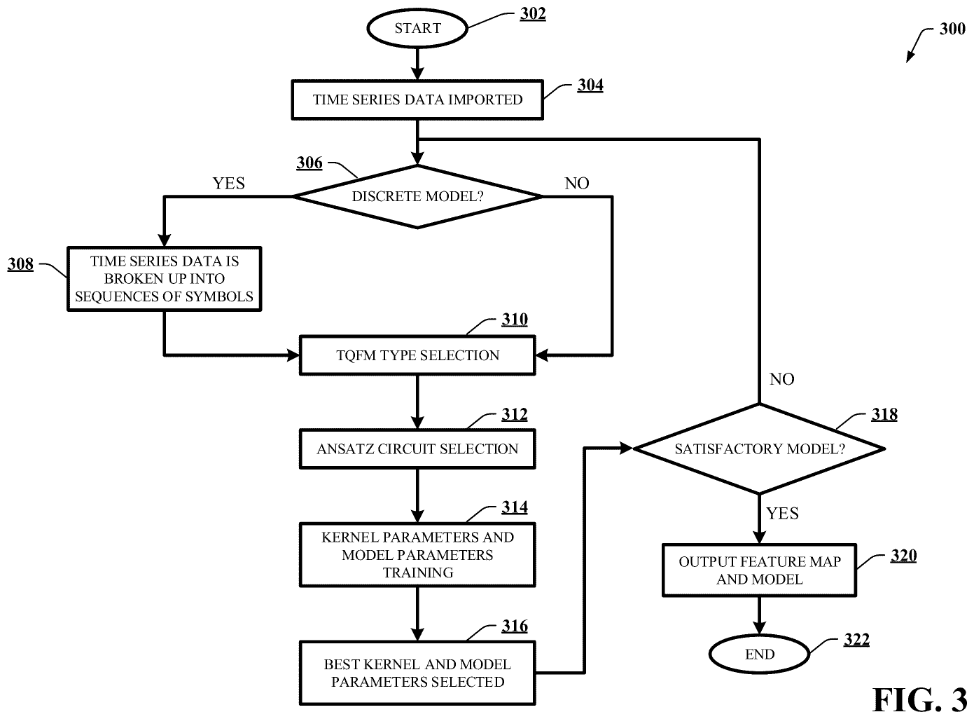

Further, in various embodiments, a number of qubits of a TQFM can be a hyperparameter that is not directly determined by a length of an input sequence to be embedded. For example, considering a unitary TQFM, a number of qubits of the TQFM quantum circuit can be independent of the length of a sequence being embedded. Rather, the number of qubits of a feature map or reservoir can be a hyperparameter not directly determined by the length of the sequence (e.g., a time series sequence/bitstring/binary sequence) to be embedded. For example, for mapping binary sequences to quantum states with parameterized TQFMs, U(θ), a TQFM quantum circuit can map sequences of different length as follows. For two binary sequences s₁=010 of length 3 (i.e., 3 data points, 0, 1 and 0) and s₂=11 of length 2 (i.e., 2 data points, 1 and 1), s₁ and s₂ can be respectively represented as parameter vectors θₛ_{₁} and θₛ_{₂}. Sequences s₁ and s₂ can be embedded as given by equation 1 and equation 2, respectively. In equation 1 and 2, |0 [symbol] ^{⊗n}, wherein n can represent the same number of qubits for TQFM circuits U(θₛ_{₁}) and U(θₛ_{₂}). In general, equations 1 and 2 can be represented as θₛ→U(θₛ)|0 [symbol] =Πᵢ₌₀^{N} Uᵢ (θᵢ)|0 [symbol] . A corresponding quantum kernel function for sequences s₁ and s₂ can be a pure state fidelity given by equation 3. Additional aspects of training the model employed by forecasting module 204 are discussed in greater detail with reference to FIG. 3.

FIG. 3 illustrates a flow diagram of an example, non-limiting method 300 for training a forecasting model using a TQFM in accordance with one or more embodiments described herein. One or more embodiments discussed with reference to FIG. 3 can be enabled by one or more components of FIG. 1. Repetitive description of like elements and/or processes employed in respective embodiments is omitted for sake of brevity.

Various embodiments herein can leverage dynamics of open quantum systems to encode sequence data into a quantum state. The approach can be implemented on physical quantum hardware with circuit-based quantum computing leveraging dynamic circuits with mid-circuit measurements and resets. Thereafter, quantum states encoding sequence data can be used to define kernel elements between pairs of sequences using different metrics (e.g., fidelity estimation). The kernel matrix can then be used to train a model (e.g., a classifier) that can predict the next symbol in a sequence. In calculating kernels, sequences of equal as well as variable lengths can be encoded. The model can be a traditional support vector classifier with quantum states, and the model structure can be optimized through a variety of implementations, including grid search, combined dual annealing and evolutionary optimization, etc.

With continued reference to FIG. 2, non-limiting method 300 can describe a model training process with a TQFM kernel for the model employed by forecasting module 204 to make predictions for financial time series. Non-limiting method 300 can train one model or multiple models with a TQFM kernel.

Non-limiting method 300 can begin at 302, and at 304, time series data of interest can be imported to classical computer 202. The time series data can be received by classical computer 202 in the form of bitstrings, or the time series data can be broken into sequences of symbols (e.g., binary, decimal, etc. symbols) as a first split.

At 306, non-limiting method 300 can apply a parameter to determine whether the model is discrete. In some embodiments, the parameter can be a hyperparameter in itself to be optimized (e.g., by optimization component 110), for example, on a parameter grid search. If the model is discrete, non-limiting method 300 can proceed to 308, wherein the time series can be broken up into sequence(s) of symbols to be used for training or inference. If the model is continuous, non-limiting method 300 can proceed to 310.

At 310, a TQFM type can be selected. In some embodiments, the TQFM type can be a non-unitary, unitary, reservoir, etc. In other embodiments, the TQFM type can be a parameter in itself to be optimized (e.g., by optimization component 110), for example, on a parameter grid.

At 312, an ansatz circuit for the TQFM can be selected (e.g., by training component 112). In some embodiments, the ansatz circuit can have trainable parameters to be optimized. In other embodiments, the ansatz circuit can be a parameter in itself to be optimized, for example, on a parameter grid. Different ansatz can be used as data is embedded to the quantum state, which can provide different options for training the model (e.g., by training component 112) before generation of the kernel matrix.

At 314, training component 112 can train both, the feature map/kernel parameters and model coefficients applied to kernel elements. At 316, optimal kernel and model parameters can be identified. In an embodiment, a local optimization can be implemented with an optimizer. The optimizer can be selected from a group comprising Nelder-Mead, Powell, Conjugate Gradient (CG), Broyden-Fletcher-Goldfarb-Shanno (BFGS), Newton-CG, L-BFGS-B, Truncated Newton (TNC), Constrained Optimization By Linear Approximation (COBYLA), Sequential Least SQuares Programming (SLSQP), dogleg, or trust-NCG. In another embodiment, a global optimization such as, for example, dual annealing can be applied.

As stated elsewhere herein, a quantum kernel function can be a suitable quantum similarity measure or metric calculated with TQFMs computed with a quantum algorithm such as an inversion test, for pure states, or a fidelity algorithm, for mixed states. A kernel matrix can be used with labelled sequence samples to build a quantum-enhanced SVM or another kernel-based estimator.

At 318, non-limiting method 300 can determine performance of the model. If the model performance is satisfactory, non-limiting method 300 can output, at 320, the feature map and optimized parameters, and the feature selection can be saved for future predictions. If the model performance is not satisfactory, the training can return to implement different hyperparameters. In some embodiments, an evolutionary algorithm can be used to identify the best feature map and parameters. Non-limiting method 300 can end at 322.

Algorithm 1 describes an algorithm that can be used by training component 112 to train the model.

Algorithm 1:

| | |
|---|---|
| qsvc = SVC(kernel=“precomputed”) | # Sklearn SVC class, |

kernel pre-computed externally
angle1, angle2 = optimizer(objective_func, x0=angles_list) # optimization of
TQFM

| | |
|---|---|
| tqfm_obj = TQFM(angle1, angle2) | # temporal quantum feature |

map (optimized)

| | |
|---|---|
| qkernel_matrix_train = quantum_kernel_matrix( | # quantum kernel |

```
matrix code below
  xdata=X,
  ydata=None,
  tqfm_obj=tqfm_obj,
  qsvm_estimator=qsvc,
)
```

| | |
|---|---|
| qsvc.fit(qkernel_matrix_train, y) | # Sklearn SVC.fit function |
| qpred = qsvc.predict(qkernel_matrix_train) | # Sklearn SVC.predict |

function

In algorithm 1, line 1 can specify an Sklearn SVC class and kernel pre-computed externally, line 2 can indicate optimization of the TQFM, line 3 can indicate the optimized TQFM, lines 4-8 can indicate a quantum kernel matrix code, line 9 can specify an Sklearn SVC.fit function, and line 10 can specify an Sklearn SVC.predict function. Algorithm 2 can indicate dependent functions and classes in connection with algorithm 1.

```
Algorithm 2:
class TQFM:
  “‘2 qubit TQFM temporal quantum feature map class”’
  def_{——}init_{——}(self, angle1, angle2):
    self.num_qubits = 2
    self.angle1 = angle1
    self.angle2 = angle2
    # save circuits and put in dictionary
    self.tqfm_block0 = self._tqfm_block0_func( )
    self.tqfm_block1 = self._tqfm_block1_func( )
    self.tqfm_block_dict = {0: self.tqfm_block0,
              1: self.tqfm_block1}
  def_tqfm_block0_func(self):
    angle = self.angle1
    num_qubits = self.num_qubits
    tqfm_block0 = QuantumCircuit(num_qubits)
    tqfm_block0.GATE1(angle, 0)
    tqfm_block0.GATE2(angle, 1)
    tqfm_block0.GATE3(0, 1)
    return tqfm_block0
  def_tqfm_block1_func(self):
    angle = self.angle2
    num_qubits = self.num_qubits
    tqfm_block1 = QuantumCircuit(num_qubits)
    tqfm_block1.GATE1(angle, 0)
    tqfm_block1.GATE2(angle, 1)
    tqfm_block1.GATE3(0, 1)
    return tqfm_block1
  def tqfm_circuit(self, array):
    num_qubits = self.num_qubits
    tqfm_circuit = QuantumCircuit(num_qubits)
    for bit in array:
      tqfm_circuit = tqfm_circuit.compose(self.tqfm_block_dict[bit])
    return tqfm_circuit
def quantum_kernel_matrix(xdata,
            ydata,
            tqfm_obj,
            qsvm_estimator,
            mode=‘train’):
  “‘
  Pre-computes kernel matrix
  If mode=‘train’, computes matrix from xdata.
  If mode=‘test’, computes matrix from xdata and ydata
  ”’
  def map_to_statevector(x):
    # using tqfm_circuit function for computing feature maps
    return Statevector.from_instruction(tqfm_obj.tqfm_circuit(x))
  if mode == ‘train’:
    length = len(xdata)
    precomp_matrix_train = np.identity(length)/2 # 1/2 will sum to 1 in addition
at the end
    # compute kernel matrix. Only computes half, then duplicates
    for i, d1 in enumerate(xdata):
      for j, d2 in enumerate(xdata):
        if i>=j:
          pass
        else:
          precomp_matrix_train[i,j] = state_fidelity(map_to_statevector(d1),
map_to_statevector(d2))
    return precomp_matrix_train + precomp_matrix_train
```

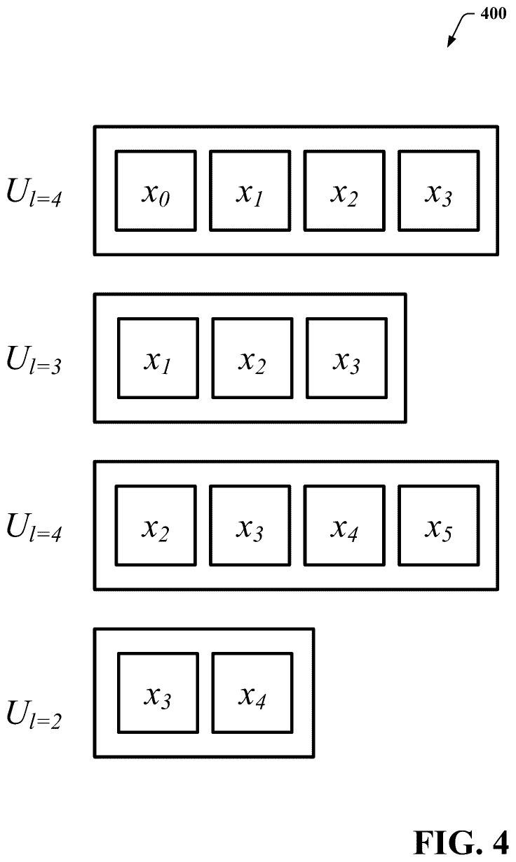

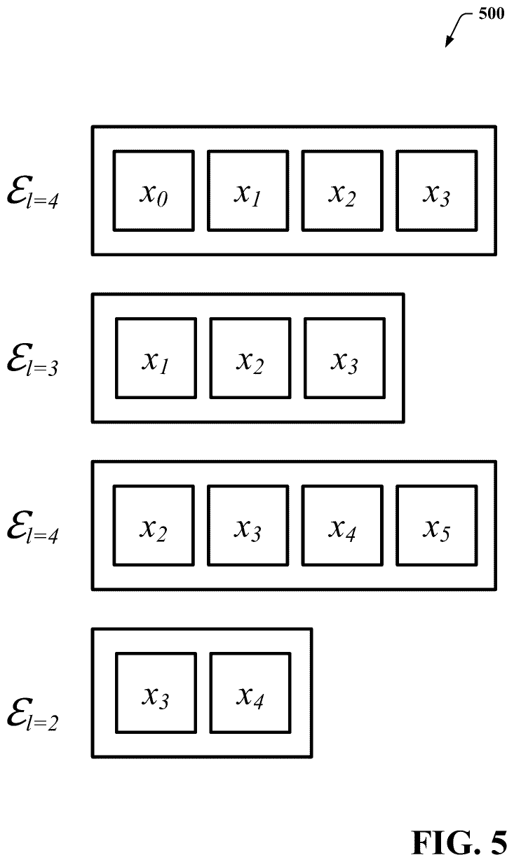

FIGS. 4 and 5 respectively describe unitary and non-unitary implementations of a TQFM as discussed in various embodiments herein.

FIG. 4 illustrates a diagram of an example, non-limiting representation 400 of quantum circuits based on a unitary TQFM in accordance with one or more embodiments described herein. One or more embodiments discussed with reference to FIG. 4 can be enabled by one or more components of FIG. 1. Repetitive description of like elements and/or processes employed in respective embodiments is omitted for sake of brevity.

Various embodiments herein can leverage dynamics of open quantum systems to encode sequence data into a quantum state. The approach can be implemented on physical quantum hardware with circuit-based quantum computing leveraging dynamic circuits with mid-circuit measurements and resets. Thereafter, quantum states encoding sequence data can be used to define kernel elements between pairs of sequences using different metrics (e.g., fidelity estimation). The kernel matrix can then be used to train a model (e.g., a classifier) that can predict the next symbol in a sequence. In calculating kernels, sequences of equal as well as variable lengths can be encoded. The model can be a traditional support vector classifier with quantum states, and the model structure can be optimized through a variety of implementations, including grid search, combined dual annealing and evolutionary optimization, etc.

With continued reference to FIG. 2, a time series xₜ₌₀, xₜ₌₁, xₜ₌₂, . . . , x_{t=N} or {xₜ}ₜ₌₀^{N} can be broken up into variable sized windows, for example, windows of sizes {k₀, k₁, k₂}. For example, the time series can be broken into sequences s₀=(xₜ₌₀, xₜ₌₁, . . . , xₜ₌ₖ_{₀}), s₁=(xₜ₌₁, xₜ₌₂, . . . , xₜ₌ₖ_{₁}), s₂=(xₜ₌₂, xₜ₌₃, . . . , xₜ₌ₖ_{₂}), and so on. In general, the sequences, sᵢ, can have different lengths and can be embedded by unitary TQFM circuits. For example, the sequence s₀ can be embedded according to the relation |ϕ(s₀) [symbol] =U(s₀)=TQFM(s₀), the sequence s₁ can be embedded according to the relation |ϕ(s₁) [symbol] =U(s₁)=TQFM(s₁), the sequence s₂ can be embedded according to the relation |ϕ(s₂) [symbol] =U(s₂)=TQFM(s₂), and so on. For a pair of sequences sᵢ and sⱼ, a temporal quantum kernel or temporal quantum kernel function can be a fidelity or other quantum similarity S, such that K(sᵢ, sⱼ)=S(|ϕ(sᵢ) [symbol] , |ϕ(sⱼ) [symbol] ).

As discussed in various embodiments, the time series xₜ₌₀, xₜ₌₁, xₜ₌₂, . . . , x_{t=N} can indicate data collected at different time steps or time intervals. For a binary series, a unitary block can encode a 0 and a 1, and the unitary block can allow a TQFM to be generated, wherein the TQFM can be half of the kernel function. Sequences of different lengths can be embedded to the TQFM with the same number of qubits. This concept can be illustrated in FIG. 4 as representations of quantum circuits. For example, Uₗ₌₄ can represent a quantum circuit encoding a time series of length 4, that is, a time series having 4 data points. Likewise, Uₗ₌₃ can represent a quantum circuit having a time series of length 3 and Uₗ₌₂ can represent a quantum circuit having a time series of length 2. Thus, the same number of qubits can be used to generate quantum circuits that can encode binary sequences of different lengths. In other words, each binary sequence can be encoded by the same number of qubits. The qubits can represent a quantum system, and the quantum system can be in different states. A bigger system can indicate a bigger field of choosing quantum states from, however, various embodiments herein can apply transformations to the same sized systems which can be measured by the number of qubits.

FIG. 5 illustrates a diagram of an example, non-limiting representation 500 of quantum circuits based on a non-unitary TQFM in accordance with one or more embodiments described herein. One or more embodiments discussed with reference to FIG. 5 can be enabled by one or more components of FIG. 1. Repetitive description of like elements and/or processes employed in respective embodiments is omitted for sake of brevity.

Various embodiments herein can leverage dynamics of open quantum systems to encode sequence data into a quantum state. The approach can be implemented on physical quantum hardware with circuit-based quantum computing leveraging dynamic circuits with mid-circuit measurements and resets. Thereafter, quantum states encoding sequence data can be used to define kernel elements between pairs of sequences using different metrics (e.g., fidelity estimation). The kernel matrix can then be used to train a model (e.g., a classifier) that can predict the next symbol in a sequence. In calculating kernels, sequences of equal as well as variable lengths can be encoded. The model can be a traditional support vector classifier with quantum states, and the model structure can be optimized through a variety of implementations, including grid search, combined dual annealing and evolutionary optimization, etc.

With continued reference to FIG. 2, a time series xₜ₌₀, xₜ₌₁, xₜ₌₂, . . . , x_{t=N} or {x_{y}}ₜ₌₀^{N} can be broken up into variable sized windows, for example, windows of sizes {k₀, k₁, k₂}. For example, the time series can be broken in to sequences s₀=(xₜ₌₀, xₜ₌₁, . . . , xₜ₌ₖ_{₀}), s₁=(xₜ₌₁, xₜ₌₂, . . . , xₜ₌ₖ_{₁}), s₂=(xₜ₌₂, xₜ₌₃, . . . , xₜ₌ₖ_{₂}), and so on. In general, the sequences, sᵢ, can have different lengths and can be embedded by non-unitary TQFM circuits. For example, the sequence s₀ can be embedded according to the relation ρ₀=ε(s₀)=TQFM (s₀), the sequence s₁ can be embedded according to the relation ρ₁=ε(s₁)=TQFM(s₁), the sequence s₂ can be embedded according to the relation ρ₂=ε(s₂)=TQFM(s₂), and so on. For a pair of sequences sᵢ and sⱼi, a temporal quantum kernel or temporal quantum kernel function can be a fidelity or other quantum similarity S, such that K(sᵢ, sⱼ)=S(ρᵢ, ρⱼ).

As discussed in various embodiments, the time series xₜ₌₀, xₜ₌₁, xₜ₌₂, . . . , x_{t=N} can indicate data collected at different time steps or time intervals. Sequences of different lengths can be embedded to the TQFM with the same number of qubits. This concept can be illustrated in FIG. 5 as representations of quantum circuits. For example, εₗ₌₄ can represent a quantum circuit encoding a time series of length 4, that is, a time series having 4 data points. Likewise, εₗ₌₃ can represent a quantum circuit having a time series of length 3 and εₗ₌₂ can represent a quantum circuit having a time series of length 2. Herein, ε can be completely positive, trace preserving quantum channels for non-unitary TQFMs. A CPTP quantum channel can be mathematically described in terms of density matrices that can represent mixed quantum status, wherein operators can evolve the density matrices, and the operators can be described as CPTP maps. The operators together are described as a quantum channel. CPTP quantum channels can be a general way of describing the evolution of a quantum system that can involve several potential evolutions, however, various embodiments herein can implement constraints to run the quantum channels on a quantum circuit. Thus, the quantum channels can have properties of complete positivity and trace preservation.

Thus, in various embodiments, the same number of qubits can be used to generate quantum circuits of different lengths that can encode binary sequences. In other words, each binary sequence can be encoded by the same number of qubits. The qubits can represent a quantum system, and the quantum system can be in different states. A bigger system can indicate a bigger field of choosing quantum states from, however, various embodiments herein can apply transformations to the same sized systems which can be measured by the number of qubits.

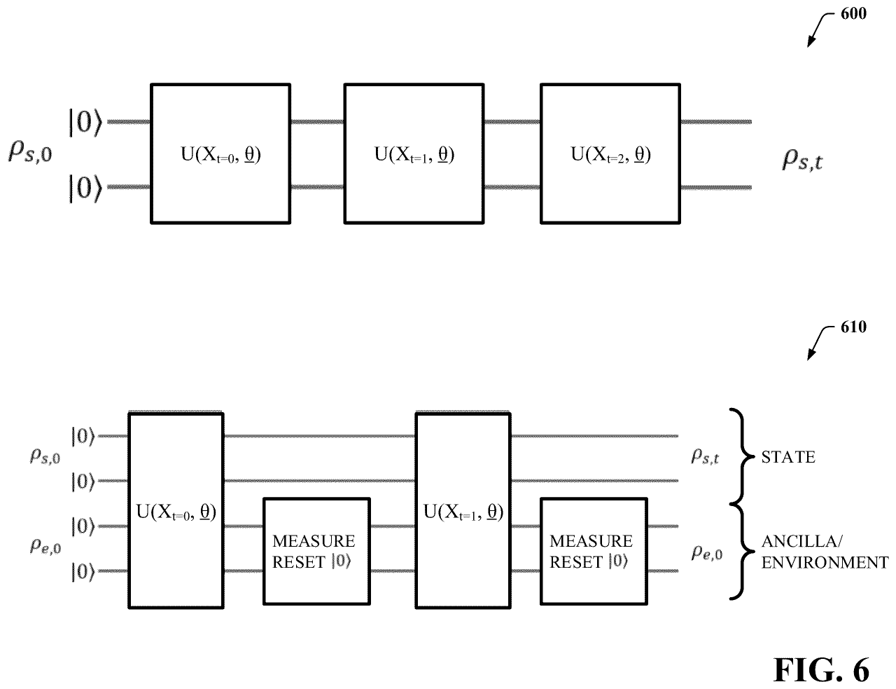

FIG. 6 illustrates diagrams of example, non-limiting quantum circuits 600 and 610 showing circuit implementations for a unitary evolution and a non-unitary evolution in accordance with one or more embodiments described herein. One or more embodiments discussed with reference to FIG. 6 can be enabled by one or more components of FIG. 1. Repetitive description of like elements and/or processes employed in respective embodiments is omitted for sake of brevity.

As discussed in various embodiments, TQFMs can be employed for kernel-based sequence prediction, using a unitary approach or a non-unitary approach. The unitary approach can utilize a unitary quantum circuit without quantum information loss from the circuit, and the non-unitary approach can utilize a quantum circuit with some information loss from the circuit. The unitary quantum circuit can comprise unitary transformations that can be applied by executing the unitary quantum circuit on a quantum computer (e.g., quantum computer 210) to embed a pair of bitstrings into a quantum space. Likewise, the non-unitary quantum circuit can comprise non-unitary transformations that can be applied by executing the non-unitary quantum circuit on a quantum computer (e.g., quantum computer 210) to embed a pair of bitstrings into the quantum space. As such, a fidelity metric can be computed between respective quantum states of a pair of sequences (e.g., binary sequences, non-binary sequences, etc.), for multiple pairs of sequences, using a unitary or a non-unitary approach, wherein the fidelities computed for various pairs of sequences can be used to generate a kernel matrix. The kernel matrix can be used in an SVM algorithm (e.g., a support vector classifier) to train (e.g., using training component 112) a model that can be employed for making time series predictions. The kernel matrix can represent classical data comprising kernel elements (e.g., fidelities or distances) that can be real number. The SVM algorithm can use the kernel matrix as input to train the model. It is to be appreciated that, in various embodiments, computations performed during a first training of the model or during subsequent retraining of the model for new sequences can be classical computations. However, the quantum computer (e.g., quantum computer 210) can be used for both training and inferencing because generating each kernel element can involve running a quantum circuit on a quantum device or simulator. In general, smaller problems can be executed on a quantum simulator.

With continued reference to FIG. 2, implementing kernels through the unitary approach can involve transformations that can be done unitarily, and unitary transformation can be reversed to compute a distance between quantum states associated with a pair of sequences. Thus, upon computing the kernel element using the set of functions discussed in various embodiments to embed classical data to a quantum state, a sequence 1101, for example, can be embedded using 4 unitary transformations/4 unitary matrices. The transformations can be inversible, which can allow the sequence 111 to be embedded using an inverse of operations used to embed the sequence 1101. Reversing all the operations applied can result in a quantum state for sequence 111. The quantum state can be a ground state, which can indicate that the states of the sequences 1101 and 111 are similar, or the quantum state can be something other than the ground state, which can indicate that the states of the sequences 1101 and 111 are different. As discussed in various embodiments herein, input sequences belonging to a class can be expected to have final TQFM quantum states that are close to each other regardless of respective sequence lengths of each input sequence.

Thus, a distance between two sequences can be computed, which can be representative of the kernel element. In practical terms, computing the kernel element can be performed by first encoding the sequence 1101 to a quantum state, and applying a reverse of the encoding operations for symbol 1, thrice, to generate a quantum state for the sequence 111. The quantum state generated for sequence 111 being close to ground state can indicate that the kernel element is close to zero, which can imply that there is no distance between the quantum state for sequence 111 and the ground state (e.g., before applying operations for sequence 1101). On the contrary, a non-zero quantum state generated for sequence 111 can indicate that the distance between the quantum state for sequence 111 and the ground state is larger. In terms of financial time series, the distance can be a fidelity between quantum states. During each computation, a quantum computer can be used to estimate a fidelity, which can be the fidelity between the quantum embeddings for sequences 1101 and 111, and the fidelity can be used to populate a kernel matrix/matrix of fidelities between all pairs of sequences. Thereafter, the kernel matrix can be used as part of an SVM algorithm. In general, in various embodiments herein, the kernel matrix can be precomputed, and the SVM algorithm can be used to build a model for predicting a financial time series. A training set can be used to train the model based on the SVM algorithm, and the model can then be used to make predictions, for example, at other times during the same day, etc.

Quantum circuit 600 can illustrate a unitary quantum circuit or unitary evolution based on an input sequence X comprising data points taken at times t0, t1, t2, etc. to generate a final state upon execution of quantum circuit 600 by a quantum computer (e.g., quantum computer 210). As discussed in various embodiments, the time interval between times t0, t1, t2, etc. can be a defined time interval such as 1 s, 5 s, etc. In quantum circuit 600, each block (e.g., U(Xₜ₌₀, θ), U (Xₜ₌₂, θ), U(Xₜ₌₃, θ), etc.) can represent instructions to perform a unitary transformation of the input sequence X, such that each block can represent a transformation for one data point of the input sequence X.

As such, in the unitary approach, based on unitary TQFMs, operations can be reversed. The non-unitary approach can involve a SWAP test to calculate kernel elements, for example, fidelity between quantum states generated or prepared in a non-unitary fashion. Quantum circuit 610 can illustrate a non-unitary quantum circuit or non-unitary evolution based on an input sequence X comprising data points taken at times t0, t1, etc. to generate a final state upon execution of quantum circuit 610 by a quantum computer (e.g., quantum computer 210). In quantum circuit 610, the taller blocks (e.g., blocks with notations U (Xₜ₌₀, θ), U (Xₜ₌₂, θ), etc.) can represent instructions to perform a non-unitary transformation of the input sequence X, such that each block can represent a transformation for one data point of the input sequence X. Such blocks can form part of quantum circuit 610 that can indicate a quantum state of a quantum system (e.g., qubits of QPU 212) upon execution of quantum circuit 610. The ‘measure reset’ blocks in quantum circuit 610 can represent an ancilla and environment used to perform measurements. The non-unitary approach has been explained in greater detail with reference to subsequence figures.

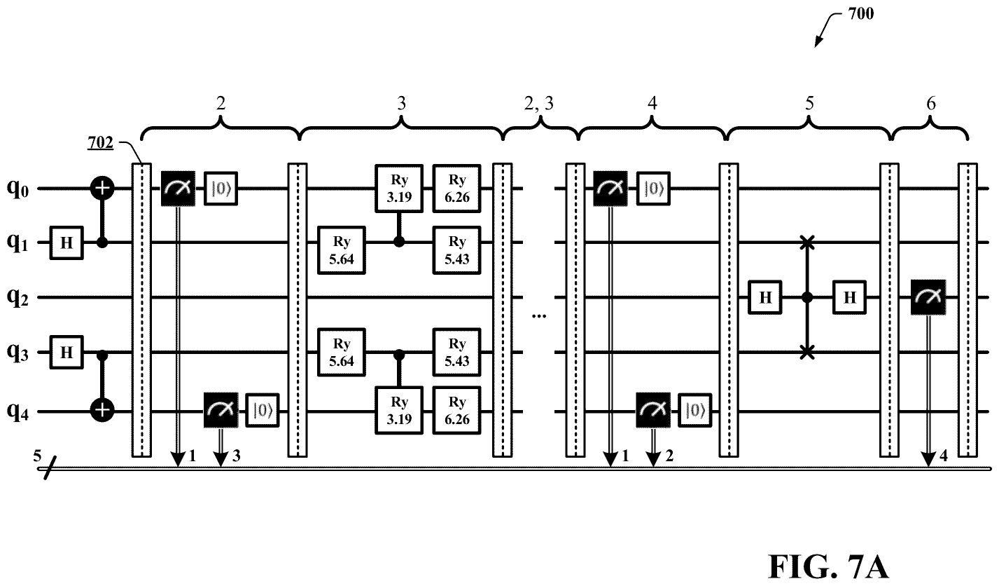

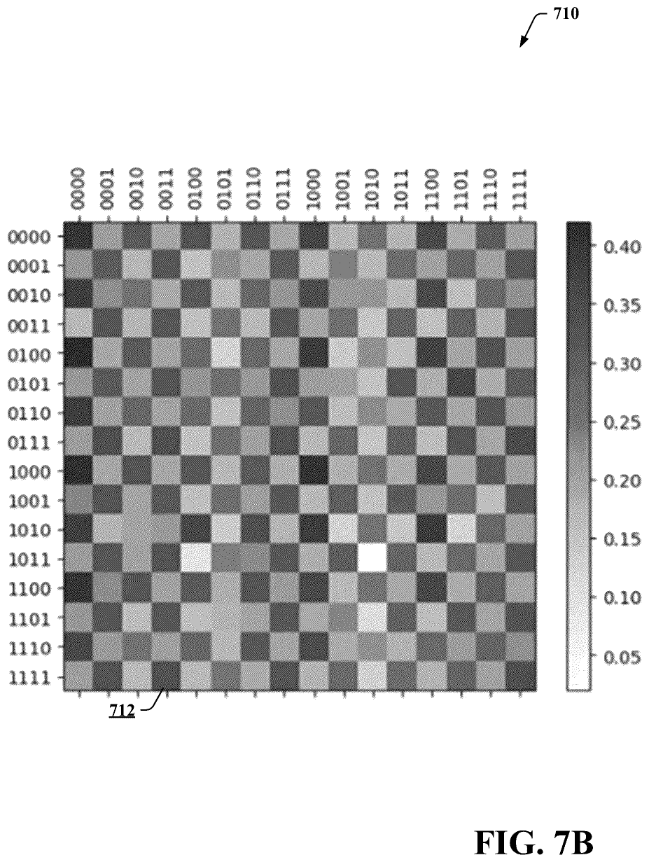

FIG. 7A illustrates a diagram of an example, non-limiting quantum circuit 700 showing a non-unitary evolution in accordance with one or more embodiments described herein. One or more embodiments discussed with reference to FIG. 7A can be enabled by one or more components of FIG. 1. Repetitive description of like elements and/or processes employed in respective embodiments is omitted for sake of brevity.

With continued reference to FIG. 6, quantum circuit 700 illustrates a non-unitary implementation for computing a kernel element, and quantum circuit 700 can be divided into sections 2, 3, 4, 5 and 6, as illustrated by the imaginary barriers, such as at 702, and the brackets. Quantum circuit 700 can be generated on a classical computer (e.g., classical computer 202) to represent a pair of binary sequences, and quantum circuit 700 can be executed on a quantum computer (e.g., quantum computer 210) to embed the binary sequences to respective quantum states through a non-unitary transformation. In quantum circuit 700, qubits q0 and q1 can correspond to a first sequence and qubits q3 and q4 can correspond to a second sequence. Assuming the imaginary barrier at 702 as a ground state level for quantum circuit 700, different operations can be applied moving towards the right-hand side of quantum circuit 700. For example, in section 3 of quantum circuit 700, a set of Ry gates can be applied to qubits, as four Ry gates for qubits q0 and q1 and four Ry gates for qubits q3 and q4. An Ry gate can be defined as a single-qubit rotation about the Y-axis. The set of Ry gates can represent one unitary operation (U). For example, the Ry gates can be applied to separate qubits as shown in quantum circuit 700, and the Ry gates can be combined into unitary operations that can act on a full vector of zero and one, illustrated in quantum circuit 700 by qubits q0 and q1. Thereafter, a measurement can be performed on the unitaries as shown by the measurement gates in section 2 of quantum circuit 700. For example, sections 2 and 3 can be repeated after the illustrated section 3.

As described elsewhere herein, in the unitary approach, unitaries can be added to an initial unitary. Further, each gate can be parametrized with a number, as evident from the numbers for the Ry gates, and the parameters can be defined. In the unitary approach, there can be only one parameter that can define each unitary which can be tied to a symbol (either 0 or 1). Thus, there can be 4 parameters that can define the first block/one unitary (e.g., the set of gates in section 3 of quantum circuit 700 or the first block in quantum circuit 610). Thereafter, the same block can be applied to the same state until a final state can be generated, wherein the qubits q0 and q1 can represent a first quantum state associated with the first sequence, and qubits q3 and q4 can represent a second quantum state associated with the second sequence. For computing the fidelity, a SWAP test can be used for a non-unitary case, as illustrated in section 5 of quantum circuit 700 through the application of Hadamard gates. A result of the SWAP test can be measured, as illustrated by the measurement gate applied to qubit q2 in section 6 of quantum circuit 700, wherein the fidelity between two quantum states can be acquired. The fidelity can be used to populate a kernel matrix, such as the kernel matrix illustrated in FIG. 7B.

FIG. 7B illustrates a diagram of an example, non-limiting colorbar plot 710 of a kernel matrix based on a non-unitary evolution in accordance with one or more embodiments described herein. One or more embodiments discussed with reference to FIG. 7B can be enabled by one or more components of FIG. 1. Repetitive description of like elements and/or processes employed in respective embodiments is omitted for sake of brevity.

Colorbar plot 710 can represent a kernel matrix that can be generated by computing fidelities between pairs of binary sequences having a length of 4 (i.e., 4 data points). Colorbar plot 710 illustrates the pairs of binary sequences used to generate a kernel matrix as a first set of sequences at the left margin and a second set of sequences at the top margin. Illustrated to the right of colorbar plot 710 is a visual map, wherein a depth of the shade can indicate the value of fidelity between two sequences in a pair. For example, square 712 in colorbar plot 710 can illustrate a fidelity computed (e.g., by computation component 108) between the sequence 1111 and the sequence 0011, and the shade of square 712 can indicate a corresponding value for the fidelity between the sequence 1111 and the sequence 0011. Further, subtracting the value for the fidelity from 1 (e.g., 1-fidelity value) can give a distance between sequence 1111 and the sequence 0011. As stated in various embodiments, colorbar plot 710 can be used to train a classical model for prediction of time series.

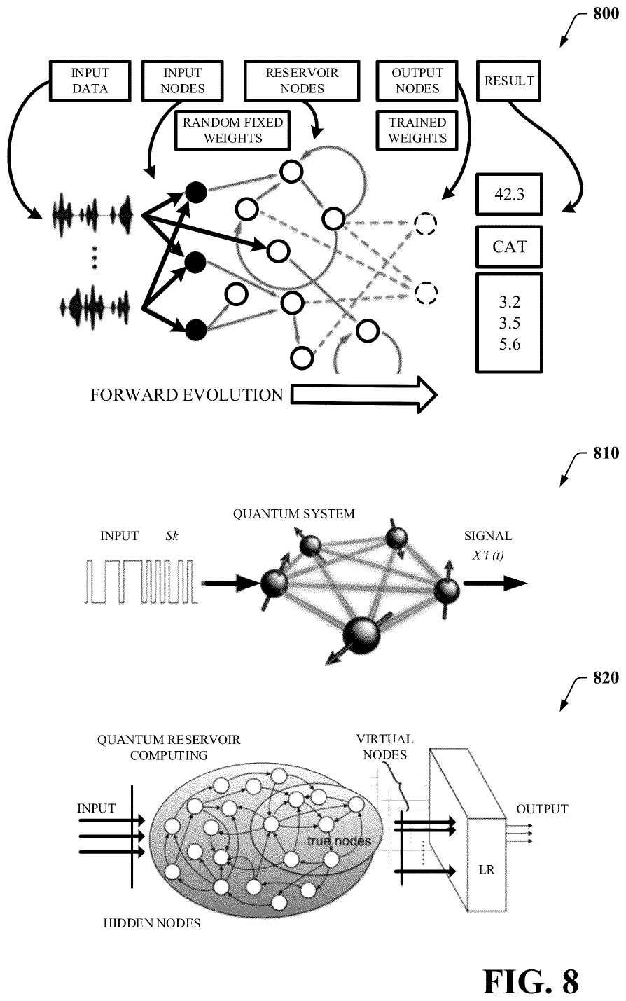

FIG. 8 illustrates at 800, 810 and 820, diagrams of example, non-limiting concepts related to reservoir computing in accordance with one or more embodiments described herein. Repetitive description of like elements and/or processes employed in respective embodiments is omitted for sake of brevity.

With continued reference to at least FIG. 1, a TQFM can have a unitary circuit design, or a non-unitary circuit design based on a quantum reservoir and open quantum systems. Illustrated in FIG. 8 are some general concepts associated with reservoirs. FIG. 8 illustrates, at 800, a reservoir approach for computing input data, at 810, a quantum system processing an input signal, and at 820, a quantum computing reservoir.

Reservoir computing (RC) can be a paradigm for sequential data or time series prediction that can draw from some of the successful properties of RNNs, such as sequential memory, while greatly improving learning efficiency by fixing reservoir weights for all but a single trainable output layer. While RC can be well-suited to dynamical system modelling, RC can be a universal approximator for sequential functions. Quantum-enhanced RC (QRC) can leverage a quantum reservoir-a natural quantum many-body system or a programmable quantum computer circuit. QRC can provide a path to quantum advantage by leveraging a quantum reservoir with an exponentially larger computational space and greater complexity for sequential data prediction. Quantum reservoir computing (QRC) can be based on the classical reservoir computing framework that can be suited to sequential/time-series data prediction. A QRC algorithm can map sequential data to a nonlinear, high-dimensional state space of a connected quantum many-body dynamical system called a reservoir. The reservoir can have a memory to hold temporal information, and the dynamics of the reservoir can be pre-determined, characterized by a coupling matrix that can be time independent. A suitable reservoir for a prediction task can be selected or can be optimized.

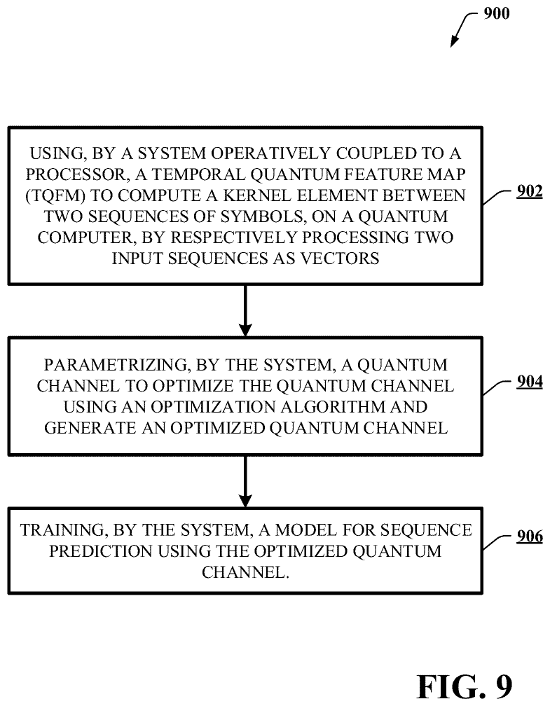

FIG. 9 illustrates a flow diagram of an example, non-limiting method 900 that can employ TQFMs for kernel-based sequential data prediction in accordance with one or more embodiments described herein. One or more embodiments discussed with reference to FIG. 9 can be enabled by one or more components of FIG. 1. Repetitive description of like elements and/or processes employed in respective embodiments is omitted for sake of brevity.

At 902, the non-limiting method 900 can comprise using (e.g., by computation component 108), by a system operatively coupled to a processor, a TQFM to compute a kernel element between two sequences of symbols by respectively processing two input sequences as vectors. In some embodiments, the qubits performing the TQFM may be simulated using a classical computer. In other embodiments, the qubits performing the TQFM may be physical or logical qubits embodied on QPU 212. Use of QPU 212 to perform the TQFM, rather than through classical simulation of qubits, may be required as the number of qubits necessary to perform the TQFM grows.

At 904, the non-limiting method 900 can comprise parametrizing (e.g., by optimization component 110), by the system, a quantum channel to optimize the quantum channel using an optimization algorithm and generate an optimized quantum channel.

At 906, the non-limiting method 900 can comprise training (e.g., by training component 112), by the system, a model for sequence prediction using the optimized quantum channel.

Various embodiments herein can employ non-limiting method 900 for calculating kernel elements between two sequences of symbols on a quantum processor or simulator, wherein the calculating can utilize a TQFM, unitary and non-unitary implementations of the TQFM, and processing input sequences or input time series as vectors of equal or different lengths. In various embodiments, the input time series can be divided (e.g., by training component 112) into sequences of binary, decimal, hexadecimal, alphanumeric, UTF-8, UTF-16, UTF-32, etc. symbols. In various embodiments, kernel element calculations can be performed (e.g., by computation component 108) using an inversion test, a fidelity algorithm or other measure of quantum similarity. In non-limiting method 900, a longer sequence can be included (e.g., by training component 112) together with subsequences of the longer sequence for model training. As discussed in various embodiments, a TQFM can be described as a quantum channel, that can be a unitary quantum channel or a non-unitary quantum channel. In various embodiments, quantum channels can be CP for non-unitary TQFMs. In various embodiments, quantum channels can be CPTP for non-unitary TQFMs. In various embodiments, quantum channels can represent non restricted dynamics of open quantum systems that can allow for information dissipation into the environment and information flow from the environment. In various embodiments, the TQFM quantum circuit or quantum channel can be parameterized so that the TQFM quantum circuit can be optimized by a suitable optimization algorithm for training a model for better sequence prediction. In various embodiments, the number of qubits of a feature map or reservoir can be a hyperparameter that is not directly determined by the length of the time series sequence to be embedded.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively employ TQFMs to generate kernel elements that can be used in a kernel matrix to train a model for sequential data prediction as the one or more embodiments described herein can enable this process. And, neither can the human mind nor a human with pen and paper embed classical data into a quantum state for computation of the kernel elements, as conducted by one or more embodiments described herein.

FIG. 10 illustrates a block diagram of an example, non-limiting operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as temporal quantum feature map code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a computation component that uses a temporal quantum feature map (TQFM) to compute a kernel element between two sequences of symbols by respectively processing two input sequences as vectors.

2. The system of claim 1, wherein the two input sequences respectively represent two input time series, and wherein computing the kernel element comprises splitting the two input time series into the two sequences of symbols.

3. The system of claim 1, wherein the two input sequences are processed as respective vectors having equal lengths.

4. The system of claim 1, wherein the two input sequences are processed as respective vectors having different lengths.

5. The system of claim 1, wherein the TQFM is a quantum channel.

6. The system of claim 5, wherein the quantum channel is completely positive (CP).

7. The system of claim 5, wherein the quantum channel is completely positive and trace preserving (CPTP).

8. The system of claim 5, wherein the quantum channel represents non restricted dynamics of an open quantum system that allows for information dissipation into an environment and information flow from the environment.

9. The system of claim 5, further comprising:
an optimization component that parametrizes the quantum channel to optimize the quantum channel using an optimization algorithm and generate an optimized quantum channel.

10. The system of claim 9, further comprising:
a training component that trains a model for sequence prediction using the optimized quantum channel.

11. The system of claim 1, wherein a number of qubits of the TQFM is a hyperparameter that is not directly determined by a length of an input sequence to be embedded.

12. The system of claim 1, wherein a longer input sequence is included with subsequent input sequences for training the TQFM, and wherein a resulting quantum state is a pure quantum state or a mixed quantum state.

13. A computer-implemented method, comprising:
using, by a system operatively coupled to a processor, a TQFM to compute a kernel element between two sequences of symbols by respectively processing two input sequences as vectors.

14. The computer-implemented method of claim 13, wherein the two input sequences respectively represent two input time series, and wherein computing the kernel element comprises splitting the two input time series into the two sequences of symbols.

15. The computer-implemented method of claim 13, wherein the two input sequences are processed as respective vectors having equal lengths.

16. The computer-implemented method of claim 13, wherein the two input sequences are processed as respective vectors having different lengths.

17. The computer-implemented method of claim 13, wherein the TQFM is a quantum channel.

18. The computer-implemented method of claim 17, wherein the quantum channel represents non restricted dynamics of an open quantum system that allows for information dissipation into an environment and information flow from the environment.

19. A computer program product for employing a TQFM for kernel-based sequential data prediction, the computer program product comprising a computer readable storage medium having program instructions embodied therewith, the program instructions executable by a processor to cause the processor to:
use, by the processor, a TQFM to compute a kernel element between two sequences of symbols, on a quantum computer, by respectively processing two input sequences as vectors.

20. The computer program product of claim 19, wherein the two input sequences respectively represent two input time series, and wherein computing the kernel element comprises splitting the two input time series into the two sequences of symbols.
